(19) United States
(12) Patent Application Publication
(10) Pub. No.: US 2026/0100090 A1
(43) Pub. Date: Apr. 9, 2026

(54) APPARATUS AND METHOD FOR BACCARAT GAMING

(71) Applicant: 3D Magiq, Singapore (SG)

(72) Inventors: Andrew MacDonald, Singapore (SG); Andrzej Surmacz, Las Vegas, NV (US)

(21) Appl. No.: 18/961,207

(22) Filed: Nov. 26, 2024

Related U.S. Application Data
(60) Provisional application No. 63/703,654, filed on Oct. 4, 2024.
(60) Provisional application No. 63/705,889, filed on Oct. 10, 2024.

(51) Int. Cl. G07F 17/32

(52) U.S. Cl. CPC G07F 17/322; G07F 17/3211; G07F 17/323; G07F 17/3244; G07F 17/3293

(57) ABSTRACT

A game incorporating Baccarat and side bets is provided. The game comprises a plurality of betting areas for placing a first wager, at least one card drawing area for placing cards to determine a winning Baccarat hand, a plurality of side-betting areas for placing a second wager, and a display for displaying information about the outcome of the game. Each side-betting area comprises a side bet sign and is associated with one of the winning Baccarat hands. A player wins the side bet if the second wager is placed on a side-betting area that is associated with the winning Baccarat hand.

### CROSS-REFERENCE TO RELATED APPLICATIONS

This application claims priority to and the benefit of U.S. Provisional Application No. 63/703,654, filed on Oct. 4, 2024, and U.S. Provisional Application No. 63/705,889, filed on Oct. 10, 2024, the entire disclosure of each of which is expressly incorporated by reference herein.

### FIELD

Aspects of one or more embodiments of the present disclosure relate to systems and methods for baccarat gaming.

### BACKGROUND

There are many kinds of card games developed for play. Card games can be played by multiple people with a dealer in a casino. Baccarat is one example of such a game. While there are many variants of Baccarat, these variants are known to share common features and elements that do not provide diverse card gaming experience to players. Accordingly, there is a need for providing a diverse card gaming experience based on various elements of gameplay.

The above information disclosed in this Background section is for enhancement of understanding of the background of the present disclosure, and therefore, it may contain information that does not constitute prior art.

### SUMMARY

One or more embodiments of the present disclosure are directed to baccarat gaming apparatuses, systems, and methods, and more particularly, to apparatuses, systems, and methods for providing diverse, interactive baccarat game experience to players.

According to one or more embodiments of the present disclosure, an apparatus for playing a game includes: a plurality of distinct demarcated betting areas, each configured for placing a first wager; at least one distinct card drawing area configured for placing a plurality of cards to determine a winning hand; a plurality of distinct demarcated side-betting areas, each configured for placing a second wager and comprising at least one side bet sign; and a physical display configured to display information about the winning hand. The winning hand is one of a player, a banker, or a tie. Each of said plurality of distinct demarcated side-betting areas is associated with one of the wining hands. A bonus payout is determined based on the winning hand. The bonus payout is provided to a user when the second wager is placed on one of said plurality of distinct demarcated side-betting areas that is associated with the winning hand.

In an embodiment, the apparatus may further include a user interface area comprising a user interface device configured to allow the user to operate playing of the game.

In an embodiment, said plurality of distinct demarcated betting areas may include: a player betting area configured to receive a player betting selection for the player, the player betting selection comprising placing of the first wager on the player betting area; a banker betting area configured to receive a banker betting selection for the banker, the banker betting selection comprising placing of the first wager on the baker betting area; and a tie betting area configured to receive a tie betting selection for the tie, the tie betting selection comprising placing of the first wager on the tie betting area.

In an embodiment, said plurality of distinct demarcated side-betting areas may include: a player side-betting area associated with the player betting area, the player side-betting area comprising at least one side bet sign; a banker side-betting area associated with the banker betting area, the banker side-betting area comprising at least one side bet sign; and a tie side-betting area associated with the tie betting area, the tie side-betting area comprising at least one side bet sign.

In an embodiment, each side bet sign may be unique.

In an embodiment, each side bet sign may include a Western Zodiac sign.

In an embodiment, each side bet sign may include an Asian Zodiac sign.

In an embodiment, each side bet sign may include one of a numeric value, text, or image representing a Western Zodiac sign or an Asian Zodiac sign.

In an embodiment, the apparatus may further include a die having a plurality of sides, each side respectively corresponds to each of the side bet signs.

In an embodiment, a winning side bet sign may be determined based on rolling of the die. The winning side bet sign may correspond to a side of the die that is facing up after rolling.

In an embodiment, the bonus payout may further be adjusted when the second wager is placed on a side-betting area comprising a side bet sign that corresponds to the winning side bet sign.

In an embodiment, the die has 12 sides.

In an embodiment, said playing may further include causing the cards to reshuffle. The user interface device may be configured to allow the user to request reshuffling of the cards.

In an embodiment, said playing may further include switching the first wager. The user interface device may be configured to allow the user to activate the switching of the first wager. The first wager placed on one of said plurality of distinct demarcated betting areas may be switched to a different betting area when the switching is activated.

In an embodiment, said playing may further include switching the second wager. The user interface device may be configured to allow the user to activate the switching of the second wager. The second wager placed on one of said plurality of distinct demarcated side-betting areas may be switched to a different side-betting area when the switching is activated.

In an embodiment, said playing may further include drawing new cards to generate a new hand, the new hand being different from a previously generated hand. The user interface device may be configured to allow the user to request the drawing of new cards.

In an embodiment, the apparatus may further include an audio output device configured to play an audio clip. The audio clip may include an announcement about the game.

In an embodiment, the apparatus may further include a computer application configured to determine the bonus payout based on the winning hand.

In an embodiment, the wining hand may include a total sum and each side bet sign may be assigned with a number.

In an embodiment, the bonus payout may be provided to the user when the total sum matches with a number assigned to a side bet sign of said one of said plurality of distinct demarcated side-betting areas.

According to one or mor embodiments of the present disclosure a system for playing a game includes: at least one processor; and at least one memory operatively connected to said at least one processor, wherein the at least one memory comprises instructions executable by said at least one processor to: graphically render a user interface area on a graphical user interface (GUI) of an electronic device, the user interface area configured to allow a user to operate playing of the game; graphically render a plurality of betting areas on the GUI, each configured for placing a first wager; graphically render a plurality of side betting areas on the GUI, each configured for placing a second wager and comprising at least one side bet sign; receive a betting selection from the user, the betting selection comprises placing of the second wager on one of the side-betting areas; graphically render a set of cards on the GUI, said set of cards comprising a hand; determine a winning hand; graphically render information corresponding to the winning hand on the GUI; and determine a bonus payout based on the winning hand. The winning hand is one of a player, a banker, or a tie. Each of said plurality of side-betting areas is associated with one of the winning hands. The bonus payout is provided to the user when said one of the side-betting areas is associated with the winning hand.

In an embodiment, said plurality of betting areas may include: a player betting area configured to receive a player betting selection for the player, the player betting selection comprising placing of the first wager on the player betting area; a banker betting area configured to receive a banker betting selection for the banker, the banker betting selection comprising placing of the first wager on the banker betting area; and a tie betting area configured to receive a tie betting selection for the tie, the tie betting selection comprising placing of the first wager on the tie betting area.

In an embodiment, said plurality of side-betting areas may include: a player side-betting area associated with the player betting area, the player side-betting area comprising at least one side bet sign; a banker side-betting area associated with the banker betting area, the banker side-betting area comprising at least one side bet sign; and a tie side-betting area associated with the tie betting area, the tie side-betting area comprising at least one side bet sign.

In an embodiment, each side bet sign may be unique.

In an embodiment, each side bet sign may include a Western Zodiac sign.

In an embodiment, each side bet sign may include an Asian Zodiac sign.

In an embodiment, each side bet sign may include one of a numeric value, text, or image representing a Western Zodiac sign or an Asian Zodiac sign.

In an embodiment, said playing may further include causing the cards to reshuffle. The user interface area may be configured to allow the user to request reshuffling of the cards.

In an embodiment, said playing may further include drawing new cards to generate a new hand, the new hand being different from a previously generated hand. The user interface area may be configured to allow the user to request the drawing of new cards.

In an embodiment, the at least one memory may further include instructions to generate an audio clip; and play the audio clip. The audio clip may include an announcement about the game.

In an embodiment, the winning hand may include a total sum and each side bet sign may be assigned with a number.

In an embodiment, the bonus payout may be provided to the user when the total sum matches with a number assigned to a side bet sign of said one of the side-betting areas.

According to one or more embodiments of the present disclosure, an apparatus for playing a game includes: a plurality of betting areas, each configured for placing a first wager for a main bet; a plurality of side-betting areas, each configured for placing a second wager for a side bet and comprising at least one side bet sign; a random number generator configured to randomly generate an outcome of the side bet, the outcome representing one of the side bet signs; a display configured to display information about the outcome; a user interface device configured to receive a betting selection from a user, the betting selection comprising placing of the second wager on one of the side-betting areas; and a computer application configured to determine a bonus payout based on the outcome of the side bet, the bonus payout is provided to the user when said one of the side bet signs represented by the outcome matches with a side bet sign of said one of the side-betting areas in which the user placed the second wager for the side bet.

In an embodiment, said plurality of betting areas may include: a player betting area configured to receive a player betting selection for a player, the player betting selection comprising placing of the first wager on the player betting area; a banker betting area configured to receive a banker betting selection for a banker, the banker betting selection comprising placing of the first wager on the banker betting area; and a tie betting area configured to receive a tie betting selection for a tie, the tie betting selection comprising placing of the first wager on the tie betting area.

In an embodiment, said plurality of side-betting areas may include: a player side-betting area associated with the player betting area, the player side-betting area comprising at least one side bet sign; a banker side-betting area associated with the banker betting area, the banker side-betting area comprising at least one side bet sign; and a tie side-betting area associated with the tie betting area, the tie side-betting area comprising at least one side bet sign.

In an embodiment, each side bet sign may be unique.

In an embodiment, each side bet sign may include a Western Zodiac sign.

In an embodiment, each side bet sign may include an Asian Zodiac sign.

In an embodiment, each side bet sign may include one of a numeric value, text, or image representing a Western Zodiac sign or an Asian Zodiac sign.

In an embodiment, said random number generator may include a die having a plurality of sides, each side respectfully corresponds to each of the side bet signs. The outcome may correspond to a side of the die that is facing up after rolling.

In an embodiment, the die may include 12 sides, each side indicates a unique side bet sign.

In an embodiment, said playing may further include causing odds for winning the side bet to change. The odds for generating each outcome representing each of the side bet signs may be randomly increased or decreased.

In an embodiment, the user interface device may be configured to allow the user to activate the causing of odds for winning the side bet to change.

### BRIEF DESCRIPTION OF THE DRAWINGS

The above and other aspects and features of the present disclosure will be more clearly understood from the following detailed description of the illustrative, non-limiting embodiments with reference to the accompanying drawings, in which:

FIG. 1 illustrates an example of a game table according to one or more embodiments of the present disclosure.

FIG. 2 illustrates an alternative embodiment of the game table.

FIG. 3 illustrates an alternative embodiment of the game table.

FIG. 4 illustrates an example of a display incorporated into the game table according to one or more embodiments of the present disclosure.

FIG. 5A illustrates a flow diagram for providing a game according to one or more embodiments of the present disclosure.

FIG. 5B illustrates a flow diagram for determining the odds for side bets according to one or more embodiments of the present disclosure.

FIG. 6 illustrates a schematic block diagram of a gaming system for playing the game according to one or more embodiments of the present disclosure.

FIG. 7 illustrates an example of a screen displaying card squeezing.

### DETAILED DESCRIPTION

Hereinafter, embodiments will be described in more detail with reference to the accompanying drawings, in which like reference numbers refer to like elements throughout. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described. Unless otherwise noted, like reference numerals denote like elements throughout the attached drawings and the written description, and thus, redundant description thereof may not be repeated.

One or more embodiments of the present disclosure relate to baccarat gaming. A gaming system or method is provided for enhancing gaming experience and playing baccarat. The gaming system or method may comprise one or more processors, one or more memories (or databases), one or more computer programs/applications (software), one or more user interfaces, and one or more displays. The gaming system or method may be presented as a gaming platform (hereinafter, the “Platform”). One example of the Platform is 3D Magiq Platform designed by 3D Magiq. The Platform is designed to facilitate all functions necessary to meet gaming compliance requirements in multiple jurisdictions. The Platform may be configured to allow for an update for implementing new regulations, new features, and/or new requirements and needs from customers. The Platform may also be configured to comprise one or more game engines that are configured to control game logics and flow. The game engines may comprise software, hardware, or both, and be configured to communicate with other elements of the Platform via a network, including an electronic game device or other elements disclosed herein, for purposes of controlling those elements.

An electronic game device (“EGD”) generally refers to any game device or machine that may be configured to be played electronically and in conjunction with the Gaming Platform. The EGD may include both electronic table games (“ETGs”) and electronic game machines (“EGMs”). The Gaming Platform may be configured to comprise EGDs as part of its system, or be configured to interact with external EGDs consistent with the descriptions provided herein. In one embodiment, the Gaming Platform may be configured to comprise physical game devices or machines such as a slot machine.

A system or method is provided for presenting a novel Baccarat game (hereinafter, the “Game”) for play by users/players (hereinafter, the terms “player” and “user” are used interchangeably). The Game incorporates certain common features of conventional Baccarat games such as CZ12 Baccarat; however, the Game employs unique and novel features that are not present in any known, conventional Baccarat game. In one embodiment, the Game comprises one or more side bets in addition to pre-existing bets in conventional Baccarat games such as a “Player,” “Banker,” and “Tie.” The side bets may comprise the Western Zodiac-themed side bets. For example, the side bets may comprise the 12 astrological signs of the Western Zodiac such as “Leo,” “Sagittarius,” “Aries,” “Capricorn,” “Virgo,” “Pisces,” “Aquarius,” “Gemini,” “Libra,” “Taurus,” “Scorpio,” and “Cancer.” Players are allowed to bet on one or more of these side bets in addition to betting on “Player,” “Banker,” and/or “Tie” in each round of the Game. Players may be awarded in various ways based on how these side bets are configured and/or how players bet on these side bets. Adding these side bets to the Game enhances the excitement of playing the Game and adds surprising effects with astrological flair.

In another embodiment, the 12 Asian Zodiac signs may be used instead of the 12 Western Zodiac signs. For example, the side bets may comprise the 12 Asian Zodiac signs such as “Rat,” “Ox,” “Tiger,” “Rabbit,” “Dragon,” “Snake,” “Horse,” “Goat,” “Monkey,” “Rooster,” “Dog,” and “Pig.” It should be apparent that these 12 Asian Zodiac signs may replace the 12 Western Zodiac signs in any order or combination, without limited to any particular order or combination. All such embodiments are anticipated as they are consistent with the spirit and scope of the present disclosure.

In one embodiment, the Game may be implemented in any form known in the art, or which may hereafter be invented, such as a game table, a game machine (kiosk), in an electronic application, or the like. It is anticipated that at least some embodiments will be implemented in casino establishments. In one embodiment, an AI-driven system, such as the Gaming Platform, may be provided for presenting the Game to players.

The traditional baccarat game such as the one being played in Asia and the United States employs the standard French deck (i.e., 52 cards deck). In other countries/jurisdictions, a Spanish card deck or other variants of the Spanish card decks are used. The Game may be played with the standard French deck, the Spanish card deck, or any variants thereof, including “Baraja Espanola,” “Baraja de 48 Cartas,” “Baraja Valenciana,” “Baraja Sevillana,” or the like. In one embodiment, 10 decks of 52 cards (e.g., French deck) may be used to play the Game. The cards may have suits removed and pips retained for card squeezing. It should be apparent that the present disclosure is not limited to any specific type of deck/card or any specific number of decks, and any suitable deck/card or any suitable number of decks may be used to play the Game.

### Embodiments of the Game Table

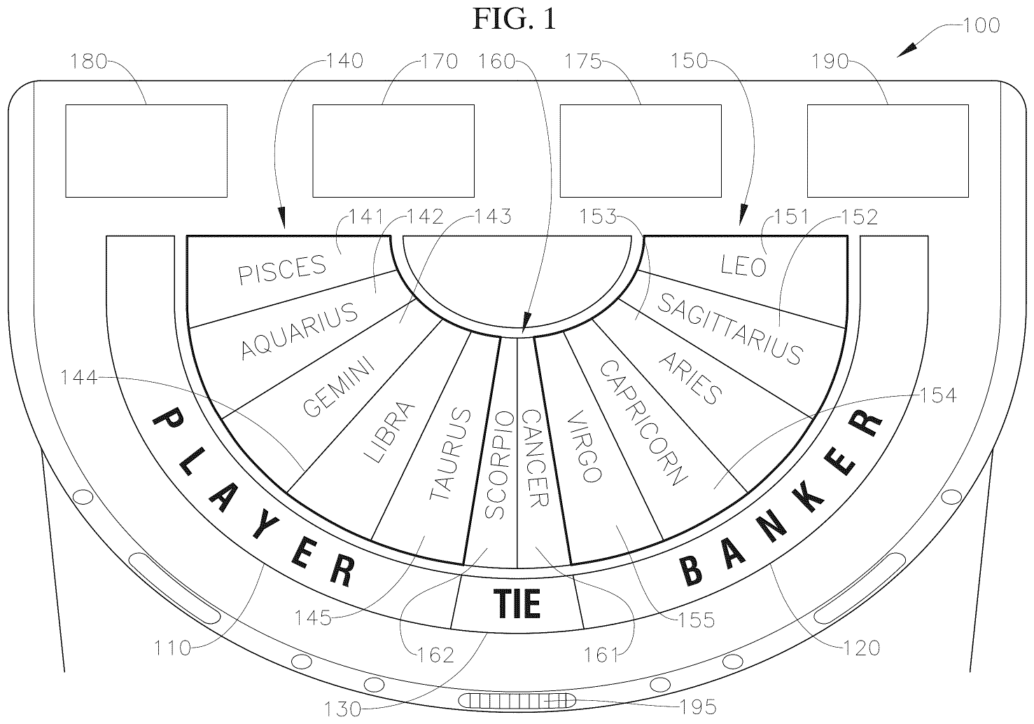

FIG. 1 shows an example of a game table for playing the Game according to one embodiment of the present disclosure. In one embodiment, a game table 100 is provided. The game table 100 may be configured for use by a single player or multiple players.

In one embodiment, the game table 100 may be provided as a physical game table that may be used in a casino or the like. In this embodiment, one or more elements of the game table 100 may be electrically displayed on one or more screens installed on the physical game table. Alternatively, the game table 100 may be provided as an electronic game that is configured to be played on a game machine in a casino. In another embodiment, the game table 100 may be provided as an electronic game table that may be electronically displayed on a display screen of an electronic device. The electronic device may include any suitable computer device such as a smartphone, tablet, desktop, computer, EGD, etc. In one embodiment, multiple electronic devices, or the game tables (or any part thereof) that are being displayed on one or more screens installed on physical game tables or game machines, may be connected with the Platform (or a server hosting the Platform) through a Local Area Network (e.g., within a casino), a Wide Area Network (e.g., between casinos), or the Internet such that the electronic devices or the game tables may communicate with each other or with the Platform/server. In one embodiment, an application may be installed on the electronic device and the Game may be configured to be played through the application running on the electronic device. In another embodiment, the game may be configured to be played on a web browser. In this embodiment, a server may be implemented to host the Game. The server may be configured to be in electrical communication with the user's electronic device via a network such as Local Area Network (LAN), Wide Area Network (WAN), and the Internet.

In the single-player embodiment, a player is provided with the game table 100 or the like. The player may play the Game by betting on any suitable betting area of the game table 100 presented to that player.

In the multi-player embodiment, the game table 100 is provided to be used by multiple players. In this embodiment, each player is provided with his or her own game table 100 or the like. Each player may play the Game by betting on any suitable betting area of the game table 100 presented to that particular player.

Still referring to FIG. 1, the game table 100 may comprise a player betting area 110, a banker betting area 120, a tie betting area 130, a player side-betting area 140, a banker side-betting area 150, and a tie side-betting area 160. The player betting area 110 may be configured for betting on Player. The banker betting area 120 may be configured for betting on Banker. The tie betting area 130 may be configured for betting on Tie. The player betting area 110, the banker betting area 120, and the tie betting area 130 may be configured for placing a main bet (e.g., Baccarat bet). For example, like the traditional Baccarat game, a player may place a wager (e.g., chips) on the player betting area 110 if the player wishes to bet on Player; may place a wager on the banker betting area 120 if the player wishes to bet on Banker; and may place a wager on the tie betting area 130 if the player wishes to bet on Tie.

The player side-betting area 140, the banker side-betting area 150, and the tie side-betting area 160 may be configured for placing a side bet. The player side-betting area 140 may comprise one or more sections for placing a wager in connection with side bet signs. In one embodiment, the side bet signs may comprise the 12 Western Zodiac signs. In other embodiments, the side bet signs may comprise other suitable signs or symbols that can be applied to the Game. For example, the side bet signs may comprise the 12 Asian Zodiac signs.

In one embodiment, the player side-betting area 140 may comprise five Western Zodiac signs, such as Pisces, Aquarius, Gemini, Libra, and Taurus, as shown in FIG. 1. In other embodiments, any other suitable number of the Western Zodiac signs or the like, and in any combination, may be included in the player-betting area 140. For example, the player side-betting area 140 may comprise any combination of two or three Western Zodiac signs or Asian Zodiac signs. In another embodiment, instead of using textual information such as shown in 140, any non-textual symbol/sign representing each Zodiac sign may be used in the Game separate from, or in addition to, the textual information. For example, the image/picture of an animal or constellation representing a Zodiac sign may be indicated in the game table.

The banker side-betting area 150 may comprise one or more sections for placing a wager in connection with the side bet signs. In one embodiment, the banker side-betting area 150 may comprise five Western Zodiac signs, such as Leo, Sagittarius, Aries, Capricorn, and Virgo, as shown in FIG. 1. In other embodiments, any other suitable number of the Western Zodiac signs or the like, and in any combination, may be included in the banker-betting area 150. For example, the banker side-betting area 150 may comprise any combination of two or three Western Zodiac signs or Asian Zodiac signs.

The tie side-betting area 160 may comprise one or more sections for placing a wager in connection with the side bet signs. In one embodiment, the tie side-betting area 160 may comprise two Western Zodiac signs, such as Scorpio and Cancer, as shown in FIG. 1. In other embodiments, any other suitable number of the Western Zodiac signs or the like, and in any combination, may be included in the tie side-betting area 160. For example, the tie side-betting area 160 may comprise any combination of two or three Western Zodiac signs or Asian Zodiac signs.

In one embodiment, each side bet sign may be assigned with a number that corresponds to one of the outcomes of Baccarat hands. For example, if a Baccarat game being played generates outcomes that range from 1 to 9, the side bet signs may be assigned with numbers that range from 1 to 9. For example, as shown in the banker side-betting area 150 of FIG. 1, in which the Western Zodiac signs are implemented, Leo may be assigned with 8; Sagittarius may be assigned with 7; Aries may be assigned with 6; Capricorn may be assigned with 5; and Virgo may be assigned with 4. In the player side-betting area 140, Pisces may be assigned with 8; Aquarius may be assigned with 7; Gemini may be assigned with 6; Libra may be assigned with 5; and Taurus may be assigned with 4. In the tie side-betting area 160, Scorpio may be assigned with 9 and Cancer may be assigned with 6. These numbers are provided only as an example, and it should be apparent that any other numbering may be assigned to the side bet signs.

In another embodiment, the Western Zodiac signs may be assigned with other suitable numbers in association with other variants of Baccarat games where a different number range is used. For example, if a Baccarat game with a number range from 1 to 8 is being played, then the side bet signs may be assigned with numbers from 1 to 8. In another embodiment, the Western Zodiac signs may be assigned with the numbers that are considered to be associated with each of the Western Zodiac Signs. For example, “Leo” is considered to be associated with numbers 1 and/or 4, and therefore, “Leo” may be assigned with 1, 4, or both. “Cancer” is considered to be associated with numbers 2 and/or 7, and therefore, “Cancer” may be assigned with 2, 7, or both. “Virgo” and “Gemini” are considered to be associated with 5, and therefore, they may be assigned with 5. “Libra” and “Taurus” are considered to be assigned with 6, and therefore, they may be assigned with 6. “Scorpio” and “Aries” are considered to be assigned with 9, and therefore, they may be assigned with 9. “Sagittarius” and “Pisces” are considered to be associated with 3, and therefore, they may be assigned with 3. “Capricorn” and “Aquarius” are considered to be associated with 8, and therefore, they may be assigned with 8.

Still referring to FIG. 1, a player is free to bet on any side bet. If the player bet on “Leo” in the player side-betting area 140, then this side bet wins when Player's hand wins in the main bet and the Player's winning hand has a total matching the corresponding value of “Leo” (e.g., 8). If the player bet on “Sagittarius” and “Virgo,” then this side bet wins when Player's hand wins in the main bet and the Player's winning hand has a total matching the corresponding value of “Sagittarius” (e.g., 7) or “Virgo” (e.g., 4). In this instance, however, if the Player's winning hand does not have a total matching any of the corresponding values of “Sagittarius” or “Virgo,” then the player losses the side bet and the player's wagers placed on both “Sagittarius” and “Virgo” are collected by a dealer/casino. If Banker's hand wins in the main bet, then the player losses the side bet as well.

If the player bet on “Pisces” in the banker side-betting area 150, then this side bet wins when Banker's hand wins in the main bet and the Banker's winning hand has a total matching the corresponding value of “Pisces” (e.g., 8). If the player bet on “Gemini” and “Libra,” then this side bet wins when Banker's hand wins in the main bet and the Banker's winning hand has a total matching the corresponding value of “Gemini” (e.g., 6) or “Libra” (e.g., 5). If the player bet on “Scorpio” in the tie side-betting area 160, then this side bet wins when the Banker hand and the Player hand ties at 9 in the main bet.

If the player wins the side bet, the player may be rewarded. In one embodiment, the reward may comprise a bonus payout. In this embodiment, the player is rewarded with the bonus payout (e.g., cash or chips), the amount of which may vary depending on the outcomes of the baccarat game. For example, if the player won both the main bet (e.g., baccarat game) and the side bet, then the player's payout in the baccarat game may be doubled or tripled, or a fixed amount of cash/chips/credits may be provided to the player as the bonus payout, in addition to the baccarat payout (e.g., main bet payout). In another embodiment, the bonus payout may comprise credits or coupons, such as a free movie ticket, free meals, free drinks, or a voucher for playing games at a casino or the like.

In another embodiment, instead of assigning specific numbers to the side bet signs, a range of numbers may be assigned to one or more of the side bet signs. For example, “Leo” may be assigned to a range of numbers from 1 to 3 and Virgo may be assigned to a range of numbers from 4 to 5. If the player bet on “Leo,” then this side bet wins when Player's hand wins in the main bet and the Player's winning hand has a total falling within the range from 1 to 3 or 4 to 5. It should be apparent that any other suitable range may be assigned to the side bet signs. For example, each side bet sign may be assigned with a number range between 1 and 12. In FIG. 1, on the player side, 1-4 may be assigned to the first sign (e.g., 141) in the player betting area; 2-5 may be assigned to the second sign (e.g., 142) in the player betting area; 3-6 may be assigned to the third sign (e.g., 143) in the player betting area; 4-7 may be assigned to the fourth sign (e.g., 144) in the player betting area; and 5-8 may be assigned to the fifth sign (e.g., 145) in the player betting area.

Still in this example, on the banker side, 6-4 may be assigned to the first sign (e.g., 151) in the banker betting area; 7-5 may be assigned to the second sign (e.g., 152) in the banker betting area; 8-6 may be assigned to the third sign (e.g., 153) in the banker betting area; 9-7 may be assigned to the fourth sign (e.g., 154) in the banker betting area; and 10-8 may be assigned to the fifth sign (e.g., 155) in the banker betting area. Still in this example, on the tie side, 11 to a pair of 9s may be assigned to the first sign (e.g., 161) in the tie betting area and 12—if the total sum of all drawn cards (2 or 3) is equal to 6 may be assigned to the second sign (e.g., 162) in the tie betting area.

In another embodiment, physical items (e.g., physical figurines, physical signs or symbols, or physical chips) representing the side bet signs may be provided. For example, a physical figurine/symbol representing an animal of one of the Asian Zodiac signs or a constellation of one of the Western Zodiac signs may be provided to players. In this embodiment, instead of betting on the side betting areas, a player may take one of the items that indicates one of the side bet signs, and place it on the player's selected betting area, e.g., the player betting area, the banker betting area, and the tie betting area. If the player bet on Player in the main bet and Player won in the main bet (e.g., baccarat game), then the player wins on the side bet as well because the player placed the side bet sign on the player's betting area. Thus, the player may be rewarded with the bonus payout. In the electronic-game embodiment, the items may be provided as virtual items to players on the display of the electronic device.

In one embodiment, the physical items may be created as figurines representing the signs of the Western or Asian Zodiac and provided to players as a reward/gift. In this embodiment, various technologies such as 3D printers or laser etching techniques may be utilized or integrated into the Platform. Players may also opt in to purchase these items through use of an electronic device or a user interface device.

In one embodiment, the Platform may be configured to reward players who successfully collect all 12 Western or Asian Zodiac signs or figurines. In another embodiment, the Platform may be further configured to reward players who collect the 12 Western or Asian Zodiac symbols or figurines in a specific sequential order.

In another embodiment, the Platform may also be configured to reward players with enhanced payouts during their birth month (e.g., “Birth Month Reward”). For example, if there is any player who is playing the Game during his or her birth month, then payouts may be configured to be increased by a fixed amount/ratio compared to typical payouts. In one embodiment, the Platform may be configured to provide an even greater reward to a player who is playing the Game on his or her actual birthday (e.g., “Birthday Bonus”). This Birthday Bonus may be determined based on the player's betting history or past spending in the casino over a specified period of time and/or based on specific criteria.

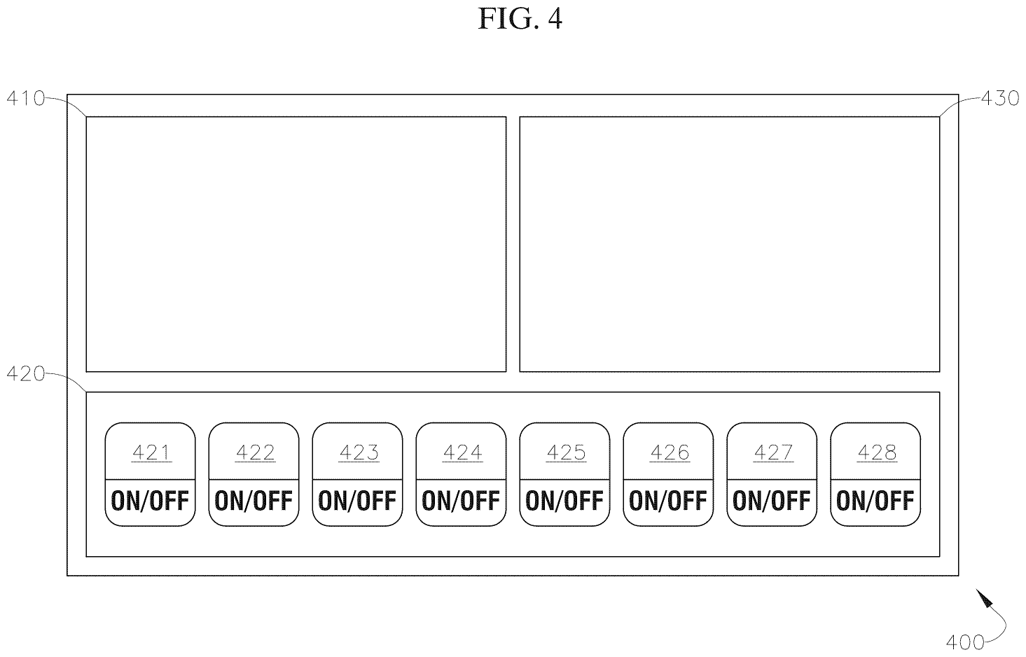

In another embodiment, the game table 100 may further comprise a player-card draw area 170, a banker-card draw area 175, a first display 180, a second display 190, and a user interface area 195. The player-card draw area 170 may be configured as a section where cards drawn for Player are placed. The banker-card draw area 175 may be configured as a section where cards drawn for Banker are placed. Cards are continued to be drawn and placed on the areas 170 and/or 175 until an outcome is determined for each round (e.g., Baccarat hand). The first display 180 and the second display 190 may comprise any display device suitable to display the information described below in connection with FIG. 4. In one embodiment, the first display 180 and the second display 190 may comprise a touchscreen display device. In this embodiment, players and/or dealer may be allowed to physically interact with the displays 180 and 190 to adjust a display mode or change the content of display.

The user interface area 195 may comprise a user interface device for interacting with players. The game table 100 may comprise one or more user interface areas 195 in any suitable location of the table. The interface device may comprise one or more buttons (either soft or hard), touch screens, keyboards, or any combination thereof that are suitable for interacting with players. In one embodiment, the interface device may comprise hard buttons. In this embodiment, a player is allowed to press one or more buttons to play the Game.

In one embodiment, each of the areas, or any one or more of the areas on the game table, such as the player betting area 110, the banker betting area 120, the tie betting area 130, the player side-betting area 140, the banker side-betting area 150, the tie side-betting area 160, the player-card draw area 170, and a banker-card draw area 175, may comprise distinctly demarcated areas on the game table. For example, these areas may be distinguished or demarcated by any type of line (e.g., solid line, dotted line, etc.) drawn on the game table, as shown in FIG. 1. Alternatively, rails, ridges, or any other suitable items/markers may be implemented on the game table to demarcate these areas.

In one embodiment, the game table 100 may be configured as a physical game table. In this embodiment, the elements of the game table 100 (e.g., 110, 120, 130, 140, 150, 160, 170, 175, 180, 190, and 195) may be provided as physical items. Alternatively, the game table 100 (or one or more elements thereof) may be provided as an electronic item that may be displayed on one or more screens/displays installed on a physical game table. In another embodiment, the game table 100 may be configured to be graphically rendered on a display of an electronic device such as a table, computer, mobile phone, etc. In this embodiment, the Game is provided as an electronic game to be played on the electronic device. For example, the game table 100 (including the elements thereof such as 110, 120, 130, 140, 150, 160, 170, 175, 180, 190, and 195) may be graphically rendered on the display of the electronic device. Players are allowed to play the Game through use of the electronic device or the like. For example, a touchscreen may be provided in the display, and players are allowed to place a wager in any betting area in the game table 100, determine the amount of the wager, interact with the dealer, etc., through use of the touchscreen or the like. Any visualized simulation of the game play may be graphically rendered on the display (e.g., a touchscreen or a display device).

In another embodiment, the game table 100 may be graphically rendered on a holographic monitor. The holographic monitor may comprise a glass-free 3D holographic display used to present the game outcomes. Any visualized simulation of the game play, e.g., card drawings, betting, rewarding, generating a random number or odds, rolling a die, etc. may be graphically rendered on the holographic monitor, providing a realistic, immersive experience that adds depth to traditional 2D game play.

The game table 100 is provided only as an example embodiment. Other designs, layouts, structures, etc. with a different number of each element in the game table 100 (e.g., 110, 120, 130, 140, 150, 160, 170, 175, 180, 190, and 195) with different shapes, sizes, or designs may be implemented. All such embodiments are anticipated as they do not depart from the spirit and scope of the present disclosure. For example, the Zodiac signs may be arranged either randomly or in sequence based on their positions in the respective calendars and each arrangement may be utilized in the side bets.

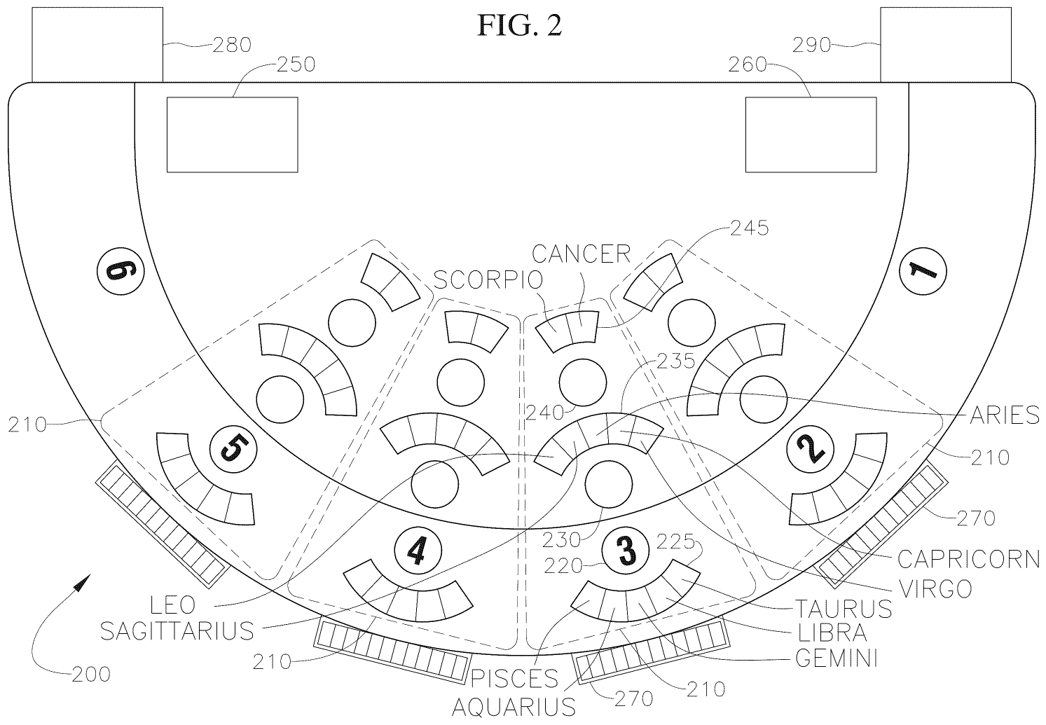

FIG. 2 illustrates an alternative embodiment of the game table. In one embodiment, a game table 200 is provided for play by multiple players. The game table 200 may comprise a plurality of player sections 210, a player-card draw area 250, a banker-card draw area 260, a user interface area 270, a first display 280, and a second display 290. The player sections 210 may be configured to be used for betting a wager by players. Each player is assigned with at least one player section 210. In one embodiment, six player sections 210 may be provided as shown in FIG. 2. But any suitable number of the player sections 210 may be implemented on the game table 200.

The player section 210 may comprise a player betting area 220, a player side-betting area 225, a banker betting area 230, a banker side-betting area 235, a tie betting area 240, and a tie side-betting area 245. The player betting area 220 may be configured as a section for placing a wager on Player. The player side-betting area 225 may be configured for side betting. For example, in one embodiment, the player side-betting area 225 may comprise five sections (like the player side-betting area 140 of FIG. 1). In this embodiment, these five sections in the player side-betting area 225 may comprise any of five side bet signs. In this embodiment, for example, the player side-betting area 225 comprises five Western Zodiac signs, including Pisces, Aquarius, Gemini, Libra, and Taurus, as shown in FIG. 2. It should be apparent that the player side-betting area 225 may comprise any other suitable number of sections, each assigned to one of the side bet signs in any combination.

The banker betting area 230 may be configured as a section for placing a wager on Banker. The banker side-betting area 235 may be configured for side betting. For example, in one embodiment, the banker side-betting area 235 may comprise five sections (like the banker side-betting area 150 of FIG. 1). In this embodiment, these five sections in the banker side-betting area 235 may comprise any of five side bet signs. In this embodiment, for example, the banker side-betting area 235 comprises five Western Zodiac signs, including Leo, Sagittarius, Aries, Capricorn, and Virgo, as shown in FIG. 2. It should be apparent that the banker side-betting area 235 may comprise any other suitable number of sections, each assigned to one of the side bet signs in any combination.

The tie betting area 240 may be configured as a section for placing a wager on Tie. The tie side-betting area 245 may be configured for side betting. For example, in one embodiment, the tie-side betting area 245 may comprise two sections (like the tie side-betting area 160 of FIG. 1). In this embodiment, these two sections in the tie side-betting area 245 may comprise any of two side bet signs. In this embodiment, for example, the tie side-betting area 245 comprises two Western Zodiac signs, including Scorpio and Cancer, as shown in FIG. 2. It should be apparent that the tie side-betting area 245 may comprise any other suitable number of sections, each assigned to one of the side bet signs in any combination.

The player-card draw area 250 may be configured as a section for placing cards drawn for Player. The banker-card draw area 260 may be configured as a section for placing cards drawn for Banker.

The user interface area 270 may comprise a user interface device for interacting with players. The game table 200 may comprise multiple user interface areas 270 that correspond to the number of players or the player sections 210. In this embodiment, each user interface area 270 may be located near each player section 210 such that players may conveniently operate the user interface device located in their respective user interface area 270 without difficulty. In one embodiment, the user interface device may comprise one or more buttons (either soft or hard), touch screens, keyboards, or the like that are suitable for interacting with players. For example, the players are allowed to operate button(s) or a touchscreen to make various requests to a casino/dealer or to play the Game, as described below. The first display 280 and second display 290 may comprise a display device, such as 180 and 190 of FIG. 1.

The game table 200 may be configured as a physical game table. In this embodiment, the elements of the game table 200 (e.g., 210, 250, 260, 270, 280, and 290) may be provided as physical items that can be used in a casino or the like. Alternatively, the game table 200 (or one or more elements thereof) may be provided as an electronic item that may be displayed on one or more screens/displays installed on a physical game table. In another embodiment, the game table 200 may be configured to be graphically rendered on a display of an electronic device such as a mobile phone, tablet, computer, or the like. In this embodiment, the Game is provided as an electronic game to be played on the electronic device.

The game table 200 is provided only as an example embodiment. Other designs, layouts, structures, etc. with a different number of each element in the game table 200 (e.g., 210, 250, 260, 270, 280, and 290) with different shapes, sizes, or designs may be implemented. All such embodiments are anticipated as they do not depart from the spirit and scope of the present disclosure.

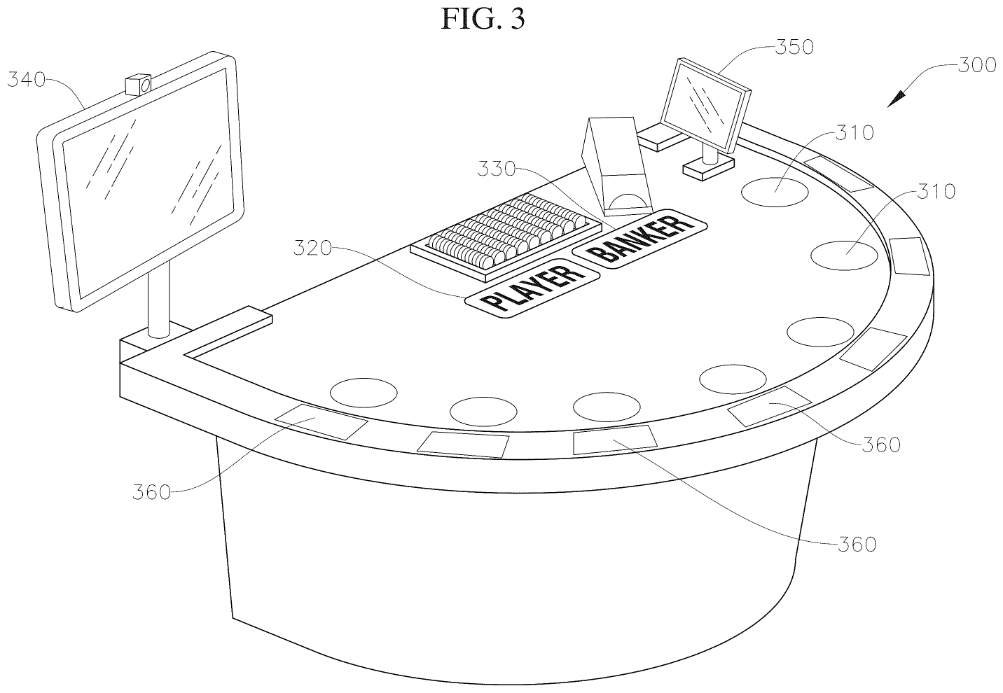

FIG. 3 illustrates an alternative embodiment of the game table. In one embodiment, the game table 300 may comprise one or more playing areas 310, a player card area 320, a banker card area 330, a first display 340, a second display 350, and a user interface area 360. In one embodiment, the playing area 310 may comprise a player section like the player section 210 of FIG. 2. In this embodiment, the player area 310 provides a place for wagering like the player section 210 of FIG. 2. Any suitable number of playing areas 310 may be provided in the game table 300. Alternatively, the whole game table 200 of FIG. 2 or the like may be incorporated into the game table 300.

In another embodiment, the player area 310 may comprise a player section like the game table 100 of FIG. 1. In this embodiment, the whole game table 100, with or without the card draw areas (170 and 175) and/or the displays (180 and 190), may be provided in the game table 300. For example, each player area 310 may comprise one game table 100. Any suitable number of the game table 100 may be provided based on the number of players who can play in the game table 300.

The player card area 320 may be configured as a section for placing cards drawn for Player. The banker card area 330 may be configured as a section for placing cards drawn for Banker.

The first display 340 and the second display 350 may comprise any display device suitable to be attached to, or incorporated into, the game table 300, such as the display (180 and 190). In one embodiment, the displays 340 and 350 may comprise a touchscreen display device. In this embodiment, players and/or dealer may be allowed to physically interact with one or more displays 340 and 350 to adjust a display mode or change the content of display.

In one embodiment, the first display 340 and/or the second display 350 may be configured to display baccarat scores. For example, the first display 340 and/or the second display 350 may be configured as a baccarat scoreboard. The baccarat scoreboard typically displays such information as Banker's winning percentages, Player's winning percentages, Tie percentages, outcome trends, etc. In one embodiment, the baccarat scoreboard may comprise Bead Road (or Bead Plate), Big Road, Big Eye Boy, Small Road, and Cockroach Pig. These terms are generally used to indicate scoreboards that are known in the baccarat game. For example, Bead Road and Big Road typically display the results of previous rounds. Big Eye Boy, Small Road, and Cockroach Pig typically display trends from past results. The baccarat scoreboard also may comprise a predictor board (e.g., predicting the next Baccarat hand), overall game statistics (e.g., the number of hands won by Banker or Player, or tied, etc.), or the like. The information shown in the baccarat scoreboard may help players spot patterns and make more informed predictions or betting decisions. In another embodiment, the first display 340 and/or the second display 350 may be configured to display other information such as Baccarat hands, the outcomes/results of the game, timer, time between games, game types, table names, denomination colors, min/max bets, game override, etc. In one embodiment, the first display 340 and/or the second display 250 may be configured as a dealer's terminal or screen. In this embodiment, the dealer's terminal or screen may be configured to display Baccarat hands, timer, game override, terminal numbers, etc.

The user interface area 360 may comprise a user interface device configured to interact with players. In one embodiment, the game table 300 may comprise multiple user interface areas 360 that correspond to the number of players or the player areas 310. In this embodiment, each user interface area 360 may be located near each player area 310 such that players may conveniently operate the user interface device located in their respective user interface area 360 without difficulty. In one embodiment, the user interface device may comprise one or more buttons (e.g., either soft or hard), touch screens, keyboards, or the like that are suitable for interacting with players. In one embodiment, the user interface area 360 may be the area 195 of FIG. 1 or the area 270 of FIG. 2.

### Additional Features/Functions

### 1. Random Number Generator for the Side Bets

In one embodiment, the outcomes of the side bets may be determined by a random number generator. For example, a random number generator may be incorporated into the Game and used to determine a winning side bet sign for the side bets. In this embodiment, any suitable type of random number generator may be configured to generate 12 different outcomes (e.g., 12 Western or Asian Zodiac signs) on a random basis. An algorithm for running the random number generator may be provided and stored on a memory in connection with the Platform. The algorithm may be modified to adjust the odds of generating each side bet sign.

In one embodiment, the side betting (e.g., betting on the Western or Asian Zodiac signs) may be played independently, separate from the baccarat game. For example, players may be allowed to bet on any of the side betting areas (e.g., 140, 150, 160 of FIG. 1) and place a wager on any of the Zodiac signs. If the random generator generates a sign (e.g., Leo) that corresponds to the side betting area on which the player placed a wager, then the player is awarded with the bonus payout. This bonus payout may be an extra reward, separate from any reward the same player may receive by winning the main bet (e.g., baccarat game). By introducing this special, extra bonus/promotion feature, players will be more entertained and motivated to play the baccarat game or any other game in a casino. In one embodiment, the bonus may comprise chips, credits, cash, etc. In another embodiment, the bonus may comprise coupons for free meals, free snacks, free drinks, free movie tickets, free show tickets, etc.

In one embodiment, the results of the random number generator may be displayed on a display such as the first display 180 or the second display 190 of FIG. 1. The random number generator may be provided as a software program, hardware, or both, as part of the Platform or the game table (e.g., 100, 200, or 300). The random number generator may also be provided remotely, in remote connection with the Platform through a network. In this embodiment, the random number generator may be controlled or manipulated through a remote access from a server/system.

In another embodiment, the random number generator may comprise a die. For example, a 12-sided die disclosed in U.S. Provisional Application No. 63/703,654 may be implemented as the random number generator. Each side of the die may be configured to indicate one of the side bet signs, resulting in having 12 different signs indicated by the 12 sides of die. In this way, all 12 Western or Asian Zodiac signs may be indicated by the 12 sides of the die. The Zodiac signs may be indicated as text (e.g., “pig”), images (e.g., an image of a pig), symbols (e.g., a symbol representing a pig) that represent the signs, or any combination of these three. Alternatively, signs other than the Zodiac signs may be indicated by the 12 sides, or some of the sides of the die may indicate the same signs. In operation, a dealer or player may roll the die in the game table 100. When the die ceases rolling movement, a side bet sign indicated on the side of the die that faces up is determined to be a winning sign. If there is any player who bet on that sign, then that player is awarded with the bonus payout.

In the table game embodiment, the die may be provided as a physical die. Additionally, a die shaker may be provided as a physical item. The die shaker may be operated by a dealer or any other person in the game table. In the electronic game embodiment, the die may be provided as a virtual die being electronically simulated on a display of an electronic device. The die shaker may also be provided as a virtual shaker. The movement and rolling of the die and the die shaker may be simulated on a display screen, for example, in the first display 180 or the second display 190. Players may be allowed to start the simulation of the movement of the die and the die shaker through use of a user interface device such as the one described in connection with the user interface area 195 of FIG. 1. For example, a touchscreen or a button may be provided as part of the user interface device that may be used by the dealer/player to trigger the movement of the die and/or the die shaker.

In another embodiment, the die may be configured to feature number dots from 1-12 instead of the Western or Asian Zodiac signs. In this embodiment, the number appearing on the side of the die facing up after rolling may be used to determine the bonus payout for players. For example, if the number associated with the Zodiac sign (e.g., 3) on which a player bet matches with the die number (e.g., three dots), then the player is rewarded with the bonus payout.

### 2. Dynamic Odds for the Side Bets

In one embodiment, the odds on the side bets (e.g., odds for winning a particular Zodiac sign) may be configured to be randomized. For example, the odds for winning one or more of the Zodiac signs may be configured to change in real-time (e.g., increased or decreased by a certain percentage or ratio), rather than being fixed. The odds associated with the side bets may be varied from one around to the next, after playing any fixed number of rounds or any fixed amount of time, etc. This feature adds an unpredictable element to the game. This feature makes the game more exciting for players, which can lead to increased engagement.

In one embodiment, the Platform may be configured to display the initial odds and the updated odds such that players can see those odds before placing their bets. For example, the first display 180 or the second display 190 (or the displays described in FIG. 2 or 3) may be configured to display the odds. In one embodiment, the Platform may be configured to change the odds on a special day (e.g. holidays or birthdays). For example, during the Chinese New Year, the odds for side bets may be increased for the upcoming year.

### 3. Generating Audio Clips

In one embodiment, the Platform may be configured to provide audio clips to inform players about the baccarat game and/or the side bets, e.g., status, game outcomes, etc. In one embodiment, the audio clips may be pre-recorded and stored on a database to be retrieved by the Platform for playback. In another embodiment, the Platform may be configured to employ an AI-based program to generate such audio clips. One example of such an AI-based program is Madge, as disclosed in U.S. Provisional Application No. 62/705,889, the entirety of which is incorporated by reference herein.

In this embodiment, the AI-based program may be configured to implement one or more Graphics Processing Units (GPUs) to handle voice recognition and responses. GPUs are particularly well suited for the tasks involved in voice recognition and response generation due to their parallel processing capabilities. For example, advanced models such as BERT (Bidirectional Encoder Representations from Transformer) or similar transformer-based architectures may be employed. Voice recognition involves converting spoken language into text, while voice response systems (e.g., virtual assistants) generate spoken responses based on the recognized text. In one embodiment, deep learning frameworks may be employed to train AI voice recognition models. Trained models may be fine-tuned on specific voice recognition tasks using GPUs, allowing for faster adaptation to new datasets. Like virtual assistants, GPUs enable real-time processing of voice recognition and provide instant responses to user queries. Audio input (e.g., audio input from a human) is first converted to text using an automatic speech recognition system. This may involve using a neural network model. The recognized text may be processed by the BERT to understand context and semantics. Attention mechanisms may be employed to weigh the importance of different words in relation to each other. After understanding the input, the AI-based program may be configured to generate a response. Finally, the generated text response is converted back into speech. By using the above method, the AI-based program may interact with a human (e.g., a player, a dealer, or any other person) to receive an audio input, interpret and analyze the audio input, generate a text response, and convert the text response to an audio clip to be announced to a player. In this embodiment, the audio input may relate to any information about the game, the main bet (e.g., baccarat game), the side bets, etc.

In another embodiment, the Platform may be configured to integrate with a large language model (e.g., LLM). In this embodiment, the Platform may be configured to determine a specific game for which the announcements will be made and decide the characteristics of voices (e.g., gender, tone, accent, etc.) that will be used for the announcements. Next, the Platform may be configured to collect a dataset of text that includes various types of announcements. For example, the dataset of text may comprise audio text information concerning (a) event outcomes (e.g., “Your bet returned $ amount win, congratulation.”) or (b) contextual information (e.g., “This game has an exciting bonus feature, which is triggered with five cherries.”). Further, the Platform may be configured to collect audio recordings of a human voice that matches the desired characteristics. For example, audio recordings of voices of celebrities reading a variety of sentences, including different intonations and emotions may be collected. The collected dataset of text or audio may cover a wide range of scenarios and phrases relevant to the announcements. Next, the Platform may be configured to select a suitable large language model that is capable of generating text-based input prompts. For example, models like GPT-3 or GPT-4 may be employed. Next, the Platform may be configured to select a TTS (Text-to-Speech) model that is capable of converting the generated text into speech. For example, models like Tacotron 2, WaveNet, and FastSpeech may be employed. Next, the Platform may be configured to tune the selected LLM on the collected text data to generate contextually relevant announcements. Next, the Platform may be configured to train the TTS model using voice recordings, involving aligning the text with the corresponding audio clips and training the model to synthesize speech that matches the voice characteristics. Next, the Platform may be configured to integrate the LLM and TTS models into a single system. The workflow may include: the generation by the LLM of the announcement text based on the event outcomes and the conversion by the TTS model of the generated text into speech.

In one embodiment, the Platform may be configured to generate audio clips comprising voices of celebrities, social media influencers, etc. The AI-based program, such as Madge, may be configured to select a personalized audio clip featuring a Zodiac-themed celebrity. In another embodiment, the Platform may be configured to generate audio clips based on deepfake technologies. In one embodiment, the audio clips may comprise announcements of potential or actual game outcomes, status of the game, trends of the game, etc. The audio clips may be played through one or more speakers installed on the game table (e.g., 100, 200, or 300). For example, one or more speakers may be installed as part of the first display 180 or the second display 190, or any suitable location in the game table 100.

### 4. Reshuffling Function

In another embodiment, the Platform may be configured to provide a player an option to reshuffle the cards. In one embodiment, the option may be provided to the player at certain points during the game, on a pre-determined basis, or on a random basis. The Platform may be configured to determine at which points during the game to allow the player to take advantage of reshuffling. For example, the Platform may be configured to make such a determination based on, or in compliance with, the rules of a casino where the Game is being played. Alternatively, the Platform may be configured to create/generate its own rules concerning reshuffling.

The reshuffling option may be presented to the player through a display device (e.g., the first display 180 or the second display 190) or the user interface device (e.g., the user interface devices described in connection with 195 of FIG. 1). The player may select the option by interacting with the user interface device, e.g., selecting a button or a menu in a touch screen in the user interface device. In the physical game table embodiment, a dealer may directly ask the player whether or not the player wishes to reshuffle the cards, or the player may directly request reshuffling to the dealer.

In another embodiment, a player may be allowed to request reshuffling of the cards. In this embodiment, the player may operate the user interface device to make such a request, e.g., selecting a requesting button or menu in the user interface device. If the player requests reshuffling, then the Platform reshuffles the cards that are currently being played. In the physical table-game embodiment, a dealer may reshuffle the cards in response to the player's request. Reshuffling adds a new element of randomness that can lead to psychological effects as players may feel more confident and optimistic with a fresh shuffle. This renewed sense of hope can, in turn, influence their betting behavior.

### 5. Switch Bet Option

In one embodiment in which the random number generator is employed to randomly generate the outcomes for the side bets, the Platform may be configured to provide a switch bet option to players. The switch bet option allows players to exchange their initial side bets for a higher-paying option after the initial odds have been randomized. In one embodiment, players may be allowed to place an initial side bet on any of the side bet signs. For example, the initial side bet may be $20 (chip) on a Western Zodiac sign, for example, “Leo.” This initial betting may be subject to the standard odds (e.g., 1:1 ratio) associated with that initial betting. The odds for winning on “Leo” may be 1:1 (e.g., if a player wins, then the player receives twice the wager amount) while the odds for winning on “Aries” may be 2:1 (e.g., if a player wins, then the player receives three times the wager amount) based on the standard odds set by the random number generator.

After the initial side bets are placed, the odds for various side bets may be randomized, creating new payout structures. For example, the odds for winning on “Leo” may remain the same (1:1) while the odds for “Aries” may be increased to 3:1. Players are then given the opportunity to switch their initial side bets to a different option that may offer higher payouts. For example, players may opt in to switch from the initial betting on “Leo” to “Aries,” which now has a higher payout (e.g., 3:1), if the player wins.

In the physical table game embodiment, the user interface device may be configured to provide an interface for players to select the switching bet option. For example, such an interface may comprise a button or a touch screen allowing players to interactively select the switching bet option. Alternatively, a display device such as the first display 180 or the second display 190 may be configured to display the switching bet option to players as a touch screen menu. In this embodiment, players may select the switching bet option directly on the display device.

In the electronic game embodiment, the switching bet option may be presented to players on a display of an electronic device. For example, a virtual button or a touch screen may be provided to players to select the switching bet option.

In one embodiment, the odds associated with the side bets may be displayed to players. For example, a display device such as the first display 180 or the second display 190 may be configured to display the odds associated with the Zodiac signs, including the updated odds that are re-generated after players place initial wagers.

In one embodiment, switching of the side bets may be configured to be subject to a percentage commission. For example, a certain percentage of the payout obtained by selecting the switching option may be deducted from the player's total wager at the end of each round or the game. This switching option allows players to develop strategies around the switch bet option, such as timing their switches based on their assessment of the odds, current bankroll or other factors frequently exploited by players primarily in the Asian culture. This feature adds a layer of strategy and decision-making to the game, enabling players to capitalize on potentially more lucrative betting opportunities.

### 6. Automatic Generation of Baccarat Hands

In one embodiment, the Platform may be configured to automatically generate baccarat hands when it is idle (e.g., when no wagering activity is occurring). For example, new hands of baccarat game (e.g., new cards) may be drawn even when no wagering activity is occurring. This feature allows players to monitor cards being dealt and to analyze patterns being formed before they make betting decisions. In one embodiment, this function may be selectively turned on or off by a system operator, a dealer, or a player. For example, a user interface device (e.g., the user interface device described in connection with the user interface area 195) may be provided for selectively turning on or off this function.

### 7. Rapid Deal Function

In one embodiment, the Platform may be configured to provide a rapid deal function. The rapid deal function may be requested by a player or a dealer. Once this is requested, new hands of baccarat are generated. The rapid deal function may be used only to build trends, and thus, this function may be made available when idle. The rapid deal function is designed to speed up the trend building. In one embodiment, the user interface unit 195 may be configured to comprise an interface for players to request the rapid deal function. For example, the interface may comprise a button, touchscreen, keyboard, etc., which is operable by a player to request the rapid deal function. Rapidly dealing and displaying multiple hands of baccarat game at once contribute to forming baccarat trends.

In one embodiment, the Platform may be configured to allow a system operator, a dealer, or a player to selectively activate or deactivate any of the above-descripted features or functions, including the rapid deal function, automatic generation of baccarat hands, switching bet option, reshuffling function, audio clips function, dynamic odds function, and the random generator function. For example, the Platform may provide a separate interface for the operator to activate or deactivate one or more of those features or functions. The Platform is intended and designed to be used in many countries/jurisdictions. To comply with regulations and/or laws of each jurisdiction in which the Platform may be implemented, the operator may need to selectively activate or deactivate some of these features/functions.

### 8. Player Profile and Player Profile Database

In one embodiment, the Platform may be configured to store data on a database. The data may comprise the outcomes of the main bet (e.g., baccarat game), the outcomes of the side bets, each player's wagers and winning/losing history, etc. The database may be the Player Profile Database, as disclosed in U.S. Provisional Application No. 63/705,889, the entirety of which is incorporated by reference herein. The database may be configured to store other information such as each player's game preferences, venue preferences, food preferences, game setting preferences, etc. Players may be authenticated through various methods, as disclosed in U.S. Provisional Application No. 63/705,889. Once authenticated, information such as the player's wagers and winning/losing history (both the baccarat game and side betting) may be stored and updated on the Player Profile Database.

In one embodiment, the Platform may be configured to provide personalized features of the Game to players based on their respective Player Profiles stored on the Player Profile Database. A Player Profile is created when a player creates an account associated with the Platform. The Player Profile may comprise personal information of the player such as a birthday, age, photo ID, etc. For example, the Platform may be configured to use an AI engine to provide personalized audio clips announcing the status or outcome of the Game to a player based on the player's game preferences, such as game volatility, game types, denomination, wager amounts/sizes, etc. In another example, the Platform may be configured to use an AI engine to analyze the player's historical session data (e.g., wager amounts, amount won, etc.) and/or game setting preferences (e.g., volatility level) to provide personalized odds for the side bets. If the player tends to bet a higher wager amount or prefers a high volatility level, then the Platform may be configured to generate greater odds for the side bets. As another example, the Platform may be configured to automatically track a player's birth month or birthday, and provide “Birth Month Reward” or “Birthday Bonus,” as described above. In another example, the Platform may be configured to use an AI engine to provide personalized game themes, game graphics, and particular sounds based on the player's preferences.

### Embodiments of Display

FIG. 4 illustrates an example of a display incorporated into the game table according to one or more embodiments of the present disclosure. In one embodiment the display 400 may be the first display 180 or the second display 190. In another embodiment, the display 400 may comprise any display device suitable for electrically displaying the information that is described to be presented to players/dealers in this application.

The display 400 may comprise a scoreboard section 410, an interface section 420, and a side-bet section 430. The scoreboard section 410 may display a baccarat scoreboard that includes information such as Bead Road (or Bead Plate), Big Road, Big Eye Boy, Small Road, and Cockroach Pig. The information displayed in the scoreboard section 410 may be updated in real-time based on the progress and status of the baccarat game that is being played. In one embodiment, the whole display 400 may comprise only the scoreboard section 410, only the interface section 420, or the only the side-bet section 430. In another embodiment, the whole display 400 may comprise any combination of at least two of the three sections: the scoreboard section 410, the interface section 420, and the side-bet section 430.

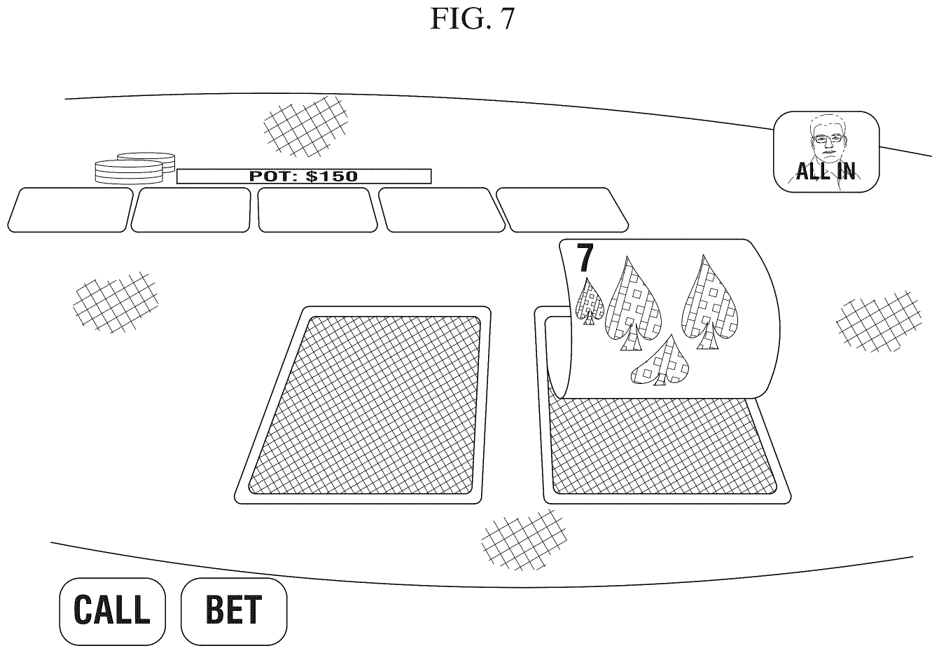

The interface section 420 may display one or more interfaces that are used for interacting with players/dealers as described herein. In one embodiment, the interface section 420 may comprise a reshuffle button 421, a dynamic odds button 422, a switch betting button 423, a rapid deal button 424, a side-bet start button 425, a card squeeze button 426, and a hands generation button 427. The reshuffle button 421 is configured to be used by a player to activate reshuffling as described above. The switch betting button 423 may be configured to be used by a player to activate the switch betting option as described above. The rapid deal button 424 may be configured to be used by a player to activate the rapid deal function as described above. The side-bet button 425 may be configured to be used by a player to trigger the random number generator to generate the outcome of the side bet as described above. The squeeze button 426 may be configured to be used by a player to simulate the squeezing of a card. Alternatively, the squeeze feature may be provided as a touch screen interaction, e.g., allowing the player to rub the card image on the screen, which will cause the card to be virtually revealed, as shown in FIG. 7. The card squeezing in baccarat is a popular technique used by players to enhance the suspense and excitement of the game. In a physical table game, players can use their fingers to gently squeeze the edges of the card to peek at the card gradually. This method builds anticipation and creates a more engaging experience for both the player and those who are watching the game. When the squeeze button 426 is activated, instead of being flipped over quickly, the edges of the card may be slowly revealed to the player such that the player may see the information indicated on a hidden side of the card. This squeezing process may be visually simulated on the display of the electronic device. The hands generation button 427 may be configured to be used by a player to activate the automatic hands generation function as described above.

The buttons of the interface section 420 may be configured as hard buttons or virtual/soft buttons. In one embodiment, one or more of these buttons may be configured as a touch screen button in a display device. In one embodiment, the interface section 420 may further comprise an additional interface for selectively turning on or off each of the buttons in the interface section 420. For example, each button may further comprise an additional switch (“On/Off”) as shown in FIG. 4. When the switch is turned on, the corresponding function can be activated. But when the switch is turned off, the corresponding function cannot be activated.

It should be apparent that other designs, layouts, structures, etc. with a different number of each element in the interface section 420 (e.g., 421, 422, 423, 424, 425, 426, and 427) with different shapes, sizes, or designs may be implemented. Further, any additional buttons may be added to the interface section 420. All such embodiments are anticipated as they do not depart from the spirit and scope of the present disclosure.

The side-bet section 430 may display the odds of winning the side bets. In one embodiment, the side-bet section 430 may display the odds for winning each of the side bets, e.g., each of the 12 Western or Asian Zodiac signs. In another embodiment, the side-bet section 430 may display not only the current odds for winning the side bets, but also the past odds and/or updated odds of the side bets. In one embodiment, the odds may be displayed as numbers representing a winning ratio/percentage/probability or the like for each side bet.

The side-bet section 430 may also be configured to display the simulated movement of the random number generator and/or the 12-sided die.

### Methods for Providing and Playing the Game

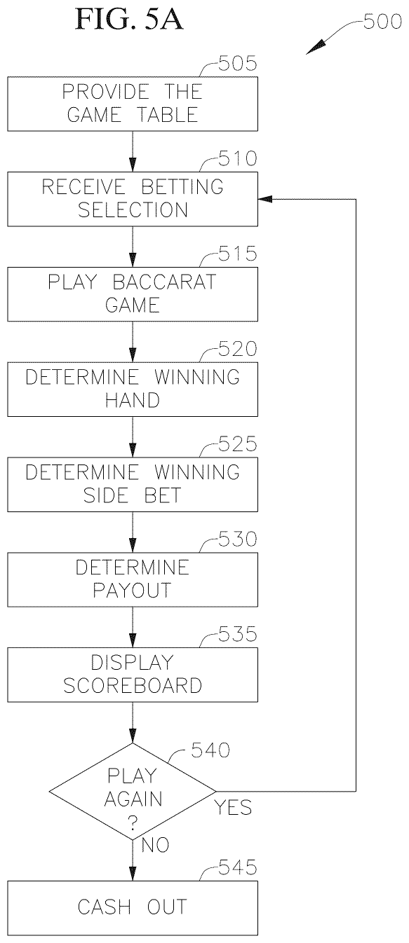

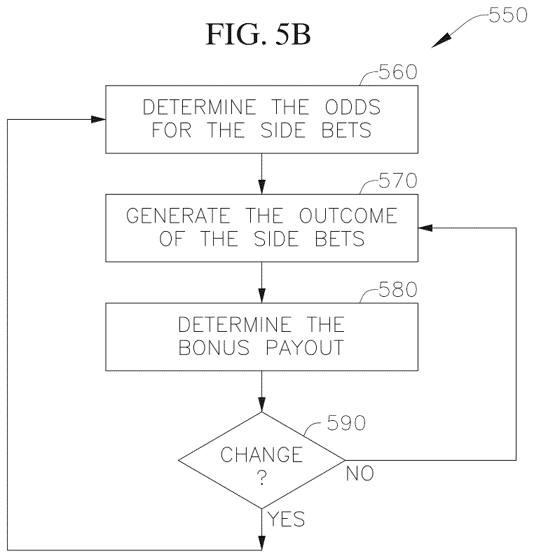

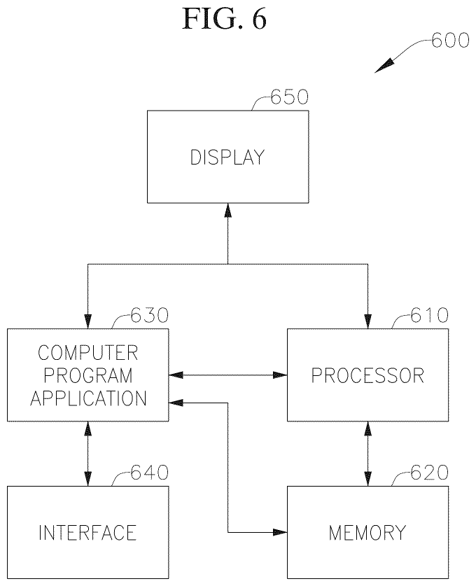

FIG. 5A shows a flow diagram for providing the Game according to one or more embodiments of the present disclosure. FIG. 5B shows a flow diagram for determining the odds for the side bets according to one or more embodiments of the present disclosure. FIG. 6 shows a schematic block diagram of a gaming system for playing or providing the Game according to one or more embodiments of the present disclosure. For example, the system 600 of FIG. 6 may be configured to perform the methods illustrated by flowcharts 500 and 550 in FIGS. 5A and 5B. However, the present disclosure is not limited to the sequence or number of the operations of the method illustrated by flowcharts 500 and 550, and can be altered to any desired sequence or number of operations as would be evident to one skilled in the art. For example, in some embodiments, the order may vary, some of the processes may be performed concurrently or sequentially, the method may include fewer or additional operations, or the like.

Referring to FIG. 5A, the method 500 starts with providing the game table at block 505. The game table (e.g., 100, 200, 300) may be provided as a physical game table or as an electronic game table to players. The physical game table may be provided in a casino or the like. The electronic game table may be provided to players as a mobile app that is configured to be installed and run on a mobile device, a software program that is configured to be downloaded and run on a computer or the like, or an application/program that is configured to be executed on a website, allowing a player to play the Game on the game table. In this embodiment, the game table is electronically displayed on an electronic device, or an electronic device (or a game machine) located in a casino.

Next, at block 510, the player is allowed to make a betting selection, and the betting selection is received by the Platform. In one embodiment, the player makes a betting selection on the side bets. For example, the player is allowed to bet on at least one of the side bet signs, along with betting on any of the other betting areas for the baccarat game, e.g., the player betting area, the banker betting area, and the tie betting area. In another embodiment, the player may be allowed to bet only on the side bets. In the electronic game embodiment, players are allowed to make a betting selection through use of the user interface device in the user interface area (e.g., 195).

Next, at block 515, the baccarat game is played, and new cards are drawn to create Banker's and Player's hands. The Banker hands are placed on the banker-card draw area. The Player hands are placed on the player-card draw area. The cards are drawn until an outcome is reached (e.g., Banker's win, Player's win, or Tie).

Next, at block 520, a winning hand is determined. The winning hand may be Player's hand, Banker's hand, or Tie. A total sum of the winning hand is also determined.

Next, at block 525, a winning side bet is determined. In one embodiment, the winning side bet is determined to be a side bet sign (e.g., a Western or Asian Zodiac sign) placed in the winning hand area and having a number corresponds to the total sum of the winning hand of the baccarat game. For example, if the winning hand was Player's hand and the total sum of the winning hand was 7, then the winning side bet is determined to be a side bet sign placed in the player side-betting area and assigned with 7. In the example shown in FIG. 1, the winning side bet is determined to be “Sagittarius.” Alternatively, the winning side bet may simply be the side bet sign(s) associated with the winning hand area.

In another embodiment, instead of using the numbers assigned to the side bet signs, a winning side bet may be determined by the random number generator. In this embodiment, the random number generator may be configured to generate one of the side bet signs. The generated side bet sign becomes the winning side bet. For example, if the random number generator generated “Sagittarius,” then “Sagittarius” becomes the winning side bet. In one embodiment, the random number generator may comprise the 12-sided die. In this embodiment, if the die returned “Sagittarius” (e.g., the side of the die facing up indicates “Sagittarius”), then the winning side bet is “Sagittarius.”

Next, at block 530, a payout and/or a bonus payout is determined. In one embodiment, if the player won the baccarat game, then the player's wager amount is doubled. The double amount of the wager is provided to the player as a payout for the baccarat game. If the player also won the side bet, then a bonus payout is also determined. In one embodiment the bonus payout may comprise the player's side bet amount. In another embodiment, the bonus payout may comprise a fixed amount of cash, chips, or credits. In another embodiment, the bonus payout may comprise coupons for free meals, free movie ticket, free drinks, free show tickets, etc.

Additionally, at block 530 (or block 520 or 525), depending on the outcomes of the baccarat game or the side bets, the Platform may be configured to create and play audio clips announcing the results/outcomes of the baccarat game or the side bets. Additionally, at block 530 (or block 520 or 525), the player's Profile may be updated to reflect the outcomes of the baccarat game or the side bets, and the payout or the bonus payout the player is receiving.

Next, at block 535, a baccarat scoreboard is displayed. The baccarat scoreboard may comprise the scoreboard 410 of FIG. 4. The information described to be displayed in the scoreboard 410 may be displayed at block 535, including but not limited to, baccarat trends, the game outcomes, etc.

Next, at block 540, whether or not the Game will be played again for another round is determined. For example, the player may be prompted or allowed to determine whether or not to play the Game again for another round.

If the player decided not to play the Game again, then the player is prompted or allowed to cashout at block 545. In one embodiment, the player may cashout all of the chips/credits earned by playing the Game.

If the player decided to play the Game again for another round, then the Game is played again at block 510.

The above steps may repeat until the player decides to stop playing the Game, for example, at block 540, or at any stage of the Game. In one embodiment, the Game may be configured to be paused for a short break after played for a certain number of rounds, e.g., five rounds.

Referring to FIG. 5B, the method 550 for generating or updating the odds for the side bets is illustrated. The method starts with determining the odds for the side bets at block 560. In one embodiment, the initial odds for the side bets may be determined by the random number generator.

Next, at block 570, the random number generator generates the outcome of the side bets. Based on the generated odds, a winning side bet is determined at this step. For example, if the random number generator generated “Leo,” then the winning side bet is “Leo.”

Next, at block 580, a bonus payout is determined. The bonus payout is determined in the same manner as described above at block 530 of FIG. 5A.

Next, at block 590, whether or not the odds will be changed is determined. In one embodiment, a player is prompted or allowed to decide whether or not the current odds will be changed/updated. If it is determined that the odds are changed or updated at block 590, then the same steps 560 to 580 repeat with the changed/updated odds. If it is determined that the odds are not changed or updated at block 590, then the same steps 570 to 580 repeat with the unchanged odds. Additionally, at block 590, the player may be prompted or allowed to turn on or off the dynamic odds function, as described above in FIG. 4. If the player turns off the dynamic odds function, then the odds will not be dynamically changed in every round of the Game. If the player turns on the dynamic odds function, then the odds will be dynamically changed in every round of the Game.

Although the methods and apparatus described above, including those corresponding to the flow charts and figures in this application, have been described separately, it is anticipated that any of the methods disclosed can be implemented individually or combined in any combination. Any of the methods, apparatus, implementations, or procedures described herein can include machine-readable instructions for execution by: (A) one or more processors, (B) one or more controllers, and/or (C) any other suitable processing hardware. Any apparatus, software, or method disclosed herein can be embodied in software stored on a non-transitory tangible medium such as, for example, a flash memory, a CD-ROM, a floppy disk, a hard drive, a digital versatile disk DVD, a USB stick, or other memory devices. Those skilled in the art will recognize that the entire method and/or parts thereof could alternatively be executed by a device other than a controller and/or embodied in firmware or dedicated hardware in a known manner. For example, it may be implemented by an application specific integrated circuit (ASIC), a programmable logic device (PLD), a field programmable logic device (FPLD), discrete logic, or the like.

Although specific methods and apparatus are described with reference to flowcharts depicted herein, persons of ordinary skill in the art will appreciate that many other methods of implementing machine readable instructions may alternatively be used. For example, the order of execution of the steps may be changed, and/or some of the steps described may be changed, eliminated, or combined.

### Configuration of the Game System/Platform

FIG. 6 shows a schematic block diagram of a gaming system for playing or providing the game according to one or more embodiments of the present disclosure. The gaming system 600 is provided for playing or providing the game implemented on an electrical device. In one embodiment, the gaming system 600 may comprise the Platform.

In one embodiment, the gaming system 600 comprises a processor 610, a memory 620, a computer program/application 630, an interface 640, and a display 650. The interface 640 may be a manual interface, comprising mechanical components such as buttons and switches, etc. Alternatively, interface 640 may be an electronic interactive interface, such as a graphical user interface (“GUI”). In all such embodiments, however, the user may interact with, and operate, the gaming system 600 via interface 640.

In one embodiment, the GUI may be configured to interact with the user through the display 650 and/or the interface 640. In this embodiment, the GUI is provided on a display through which the user may physically interact to provide inputs concerning the play of the Game. For example, the GUI may be configured to prompt the user to start the Game after making a wager, by physically interacting with the GUI (e.g., touching a selectable button or option on the display). In another example, the GUI may be configured to prompt the user to determine a wager amount and place the wager on one or more of the betting areas (e.g., the player betting area, the banker betting area, the tie betting area, the player side-betting area, the banker side-betting area, the tie side-betting area, etc.) by allowing the user to touch a selectable option (e.g., touching a “Bet” button and selecting the betting area on the GUI display) or directly touch the betting area displayed on the GUI display if the display is provided as a touch screen. In another example, the GUI may be configured to allow the user to operate any of the interface buttons shown in 420 of FIG. 4 (e.g., allowing the user to touch the buttons in 420 to activate or deactivate the buttons). Any other suitable GUI may be provided for purposes of allowing the user to physically interact with the display 650 and/or the interface 640 to play the Game.

In the table game embodiment, the GUI may be implemented on a display and/or an electronic device installed or placed on the game table (e.g., 100, 200, 300), and the user may be allowed to interact with the GUI to play the Game in the same manner as described above.

In one embodiment, one or more processors 610 are capable of reading and executing logic associated with computer programs or applications 630 running on the gaming system 600. One or more processors 610 are capable of creating, manipulating, altering, and storing data and computer data structures in a non-transitory computer readable medium (e.g., the memory 620). In one embodiment, the processor 610 (and/or the application 630) may be configured to determine certain criteria/factors for playing the Game and control operation of the Game. For example, the processor 610 (and/or the application 630) may be configured to (a) determine, change, or update the outcomes of the baccarat game and/or the side bets for each round of the Game; (b) control operation of any of the functions/features described herein; (c) determine the design, shape, size, layout, or structure of the game table (e.g., 100, 200, 300) and/or the display 400, or any part thereof; (d) generate graphical representations of the game tables 100, 200, 300 and/or the display 400 (or any part thereof) for each round of the Game; (e) generate visual simulation of playing the Game or the progress of the Game; and (f) determine a reward, payout, and bonus payout for each user at the end of each round of the Game. In one embodiment, the above criteria/factors for the Game may be implemented by a manufacturer of the gaming system 600 or a person/entity that operates the gaming venue. In one embodiment, the processor 610 (and/or the application 630) may be configured to randomly determine the outcomes of the side bets. In this embodiment, the processor 610 (and/or the application 630) may comprise the random number generator to generate different variations of the outcomes, and change the odds for the side bets for each round of the Game. In one embodiment, the odds for the side bets may be selectively or occasionally changed by the random number generator.

In another embodiment, the processor 610 (and/or the application 630) may be configured to provide personalized features of the Game to players based on their respective Player Profiles, in the same manner as described above in connection with the Player Profile Database. For example, the processor 610 (and/or the application 630) may be configured to provide personalized audio clips to a player based on the player's game preferences or provide “Birth Month Reward” or “Birthday Bonus” if the player plays the Game in his or her birth month or on his or her birthday.

In another embodiment, the manufacturer (or the operating person/entity) has an option of adjusting the criteria or factors by updating the game system 600 with new software, electronic instructions, or the like. Such methods of implementing new software, electronic instructions, etc., are known in the art.

The system 600 may include persistent storage (e.g. magnetic or optical disk, PROM, flash prom or ROM, or the like) that is operable to store computer programs/applications 630, and other data that is associated with the gaming system 600. The gaming system 600 uses input and output interfaces 640 to interface with, or to communicate data with, the outside world, including users or other gaming systems or devices. Such data communication may occur directly between two systems or devices, over a local area network, over a wide area network such as the internet, wirelessly, or in any other manner known in the art for electronic data communications between two systems or devices. In some embodiments, the gaming system 600 may be configured differently without one or more of the aforementioned components.

A non-transitory computer readable medium (e.g., the memory 620) in the game system 600 is operable to store an application 630 comprising instructions that are executable by one or more processors 610 in the gaming system 600. The application 630 may be an app, a web browser, a software program, or the like, running on the gaming system 600. An app, or the like, is typically executable locally on the gaming system 600, such as a game machine, a computer, a mobile electronic device such as a smartphone or a tablet, or the like. The gaming system 600 may be in data communication with the other gaming systems or devices via any means known in the art, such as via a network like the internet, wirelessly via WiFi, via Bluetooth technology, or the like.

A user may interface with the application 630 via a user interface means associated with the gaming system 600, while corresponding computerized actions, such as methods or steps associated with practicing one or more embodiments of the present disclosure, performed either on the gaming system 600 or on another game system or device in data communication with the gaming system 600, or on a combination thereof. All such embodiments are anticipated and are deemed to be consistent with the spirit and scope of the present disclosure.

The application 630 on the gaming system 600 may be installed from a data storage medium like a CD or a USB stick, or it may be downloadable in any number of ways known in the art, such as from an application store, from a computer device or server accessible via the Internet, from a computer, from another hand-held device, or the like. The application 630 may be a software application running on a mobile electronic device such as a smartphone or a tablet, or the like.

Once the application 630 is installed, the application 630 may become a resident application on the gaming system 600. In one embodiment, the application 630 is an app and the gaming system 600 is a hand-held device such as a smartphone or a tablet. In such embodiment, the gaming system 600 is mobile, and the user is able to play the Game through his or her mobile device. In another embodiment, the application 630 is a software program running on a desktop or a laptop computer. In another embodiment, the gaming system 600 is installed in physical locations such as a casino, a restaurant, etc., where the user is able to play the Game. In some embodiments, the user may be able to play the Game with other users. In an alternate embodiment, the application 630 is a browser running on the computer device.

In one embodiment, the application 630 comprises instructions executable by the processor 610. The application 630 and processor 610 interface with a non-transitory computer readable medium, such as the memory 620. The term application is used in some instances to refer to an installed mobile app on a hand-held device, such as on a mobile communications device, smartphone, or the like. However, as a practical matter, the terms application and app may be used interchangeably. Accordingly, the functions described herein may be performed by software running on a personal computer or on a hand-held device, and therefore various terms may be used interchangeably while the methods described herein will apply to most such embodiments.

Referring to FIG. 6, a GUI of the display 650 may be configured to display the Game, the progression of the Game, or both. In one embodiment, the display 650 may be configured to display the game table (e.g., 100, 200, and 300) and the display (e.g., 400). In another embodiment, the display 650 may comprise one or more separate screens or monitors such that one screen or monitor is configured to display the Game while a different screen or monitor is configured to display the other information such as those described above in connection with the displays (e.g., 180, 190, 280, 290, 340, 350, and 400) in FIGS. 1 to 4. Alternatively, the display 650 may be configured to display the game table (e.g., 100, 200, and 300) on a first screen/monitor and the display 400 on a second screen/monitor. In another embodiment, the display 650 may be configured to display the Game and the display 400 in a single screen or monitor. In this embodiment, the display 650 may be configured to provide multiple sub-sections on its screen, thereby displaying different information in each of those sub-sections.

The interface 640 may be configured to provide control functionalities for the user to play the Game. For example, the interface 640 may serve as the user interface device described above in connection with the user interface area (e.g., 195 of FIG. 1). In one embodiment, the interface 640 may be configured to provide an interface for the user to pay money or purchase chips/credits for playing the Game and/or making a wager. In another embodiment, the interface 640 may be configured to provide an interface for the user to receive a reward, credits, a payout, a bonus payout, or the like, such as when the user is finished playing the Game.

In one embodiment, the interface 640 and/or the GUI may be configured to provide physical interaction with the user for playing the Game, as described above with respect to FIGS. 1, 2, 3, 4, and 5.

The methods and algorithms illustrated and discussed herein may have various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules, units, or other components, can be combined or segregated as hardware and/or software stored on a non-transitory computer-readable medium as modules in any manner, and can be used separately or in combination.

Although the devices, systems, apparatus and methods have been described and illustrated in connection with certain embodiments, variations and modifications will be evident to those skilled in the art. Such variations and modifications may be made without departing from the spirit and scope of the present disclosure, and are therefore anticipated. The description and teachings herein are thus not to be limited to the precise details of methodology or construction set forth herein because variations and modifications are intended to fall within the spirit and scope of the present disclosure.

What is claimed is:

1. An apparatus for playing a game, comprising:
a plurality of distinct demarcated betting areas, each configured for placing a first wager;
at least one distinct card drawing area configured for placing a plurality of cards to determine a winning hand, wherein the winning hand is one of a player, a banker, or a tie;
a plurality of distinct demarcated side-betting areas, each configured for placing a second wager and comprising at least one side bet sign, wherein each of said plurality of distinct demarcated side-betting areas is associated with one of the wining hands; and
a physical display configured to display information about the winning hand,
wherein a bonus payout is determined based on the winning hand, wherein the bonus payout is provided to a user when the second wager is placed on one of said plurality of distinct demarcated side-betting areas that is associated with the winning hand.

2. The apparatus of claim 1, further comprising: a user interface area comprising a user interface device configured to allow the user to operate playing of the game.

3. The apparatus of claim 1, wherein said plurality of distinct demarcated betting areas comprise:
a player betting area configured to receive a player betting selection for the player, the player betting selection comprising placing of the first wager on the player betting area;
a banker betting area configured to receive a banker betting selection for the banker, the banker betting selection comprising placing of the first wager on the baker betting area; and
a tie betting area configured to receive a tie betting selection for the tie, the tie betting selection comprising placing of the first wager on the tie betting area.

4. The apparatus of claim 3, wherein said plurality of distinct demarcated side-betting areas comprise:
a player side-betting area associated with the player betting area, the player side-betting area comprising at least one side bet sign;
a banker side-betting area associated with the banker betting area, the banker side-betting area comprising at least one side bet sign; and
a tie side-betting area associated with the tie betting area, the tie side-betting area comprising at least one side bet sign.

5. The apparatus of claim 4, wherein each side bet sign is unique.

6. The apparatus of claim 4, wherein each side bet sign comprises a Western Zodiac sign.

7. The apparatus of claim 4, wherein each side bet sign comprises an Asian Zodiac sign.

8. The apparatus of claim 4, wherein each side bet sign comprises one of a numeric value, text, or image representing a Western Zodiac sign or an Asian Zodiac sign.

9. The apparatus of claim 4, further comprising: a die having a plurality of sides, each side respectively corresponds to each of the side bet signs.

10. The apparatus of claim 9, wherein a winning side bet sign is determined based on rolling of the die, wherein the winning side bet sign corresponds to a side of the die that is facing up after rolling.

11. The apparatus of claim 10, wherein the bonus payout is further adjusted when the second wager is placed on a side-betting area comprising a side bet sign that corresponds to the winning side bet sign.

12. The apparatus of claim 9, wherein the die has 12 sides.

13. The apparatus of claim 2, wherein said playing further comprises causing the cards to reshuffle, wherein the user interface device is configured to allow the user to request reshuffling of the cards.

14. The apparatus of claim 2, wherein said playing further comprises switching the first wager, wherein the user interface device is configured to allow the user to activate the switching of the first wager, wherein the first wager placed on one of said plurality of distinct demarcated betting areas is switched to a different betting area when the switching is activated.

15. The apparatus of claim 2, wherein said playing further comprises switching the second wager, wherein the user interface device is configured to allow the user to activate the switching of the second wager, wherein the second wager placed on one of said plurality of distinct demarcated side-betting areas is switched to a different side-betting area when the switching is activated.

16. The apparatus of claim 2, wherein said playing further comprises drawing new cards to generate a new hand, the new hand being different from a previously generated hand, wherein the user interface device is configured to allow the user to request the drawing of new cards.

17. The apparatus of claim 1, further comprising:
an audio output device configured to play an audio clip, wherein the audio clip comprises an announcement about the game.

18. The apparatus of claim 1, further comprising:
a computer application configured to determine the bonus payout based on the winning hand.

19. The apparatus of claim 1, wherein the wining hand comprises a total sum and each side bet sign is assigned with a number.

20. The apparatus of claim 19, wherein the bonus payout is provided to the user when the total sum matches with a number assigned to a side bet sign of said one of said plurality of distinct demarcated side-betting areas.

21. A system for playing a game, comprising:
at least one processor; and
at least one memory operatively connected to said at least one processor, wherein the at least one memory comprises instructions executable by said at least one processor to:
graphically render a user interface area on a graphical user interface (GUI) of an electronic device, the user interface area configured to allow a user to operate playing of the game;
graphically render a plurality of betting areas on the GUI, each configured for placing a first wager;
graphically render a plurality of side betting areas on the GUI, each configured for placing a second wager and comprising at least one side bet sign;
receive a betting selection from the user, the betting selection comprises placing of the second wager on one of the side-betting areas;
graphically render a set of cards on the GUI, said set of cards comprising a hand;
determine a winning hand, wherein the winning hand is one of a player, a banker, or a tie, wherein each of said plurality of side-betting areas is associated with one of the winning hands;
graphically render information corresponding to the winning hand on the GUI; and
determine a bonus payout based on the winning hand, wherein the bonus payout is provided to the user when said one of the side-betting areas is associated with the winning hand.

22. The system of claim 21, wherein said plurality of betting areas comprise:
a player betting area configured to receive a player betting selection for the player, the player betting selection comprising placing of the first wager on the player betting area;
a banker betting area configured to receive a banker betting selection for the banker, the banker betting selection comprising placing of the first wager on the banker betting area; and
a tie betting area configured to receive a tie betting selection for the tie, the tie betting selection comprising placing of the first wager on the tie betting area.

23. The system of claim 22, wherein said plurality of side-betting areas comprise:
a player side-betting area associated with the player betting area, the player side-betting area comprising at least one side bet sign;
a banker side-betting area associated with the banker betting area, the banker side-betting area comprising at least one side bet sign; and
a tie side-betting area associated with the tie betting area, the tie side-betting area comprising at least one side bet sign.

24. The system of claim 23, wherein each side bet sign is unique.

25. The system of claim 23, wherein each side bet sign comprises a Western Zodiac sign.

26. The system of claim 23, wherein each side bet sign comprises an Asian Zodiac sign.

27. The system of claim 23, wherein each side bet sign comprises one of a numeric value, text, or image representing a Western Zodiac sign or an Asian Zodiac sign.

28. The system of claim 21, wherein said playing further comprises causing the cards to reshuffle, wherein the user interface area is configured to allow the user to request reshuffling of the cards.

29. The system of claim 21, wherein said playing further comprises drawing new cards to generate a new hand, the new hand being different from a previously generated hand, wherein the user interface area is configured to allow the user to request the drawing of new cards.

30. The system of claim 21, wherein the at least one memory further comprises instructions to:
generate an audio clip; and
play the audio clip, wherein the audio clip comprises an announcement about the game.

31. The system of claim 21, wherein the winning hand comprises a total sum and each side bet sign is assigned with a number.

32. The system of claim 31, wherein the bonus payout is provided to the user when the total sum matches with a number assigned to a side bet sign of said one of the side-betting areas.

33. An apparatus for playing a game, comprising:
a plurality of betting areas, each configured for placing a first wager for a main bet;
a plurality of side-betting areas, each configured for placing a second wager for a side bet and comprising at least one side bet sign;
a random number generator configured to randomly generate an outcome of the side bet, the outcome representing one of the side bet signs;
a display configured to display information about the outcome;
a user interface device configured to receive a betting selection from a user, the betting selection comprising placing of the second wager on one of the side-betting areas; and
a computer application configured to determine a bonus payout based on the outcome of the side bet, the bonus payout is provided to the user when said one of the side bet signs represented by the outcome matches with a side bet sign of said one of the side-betting areas in which the user placed the second wager for the side bet.

34. The system of claim 33, wherein said plurality of betting areas comprise:
a player betting area configured to receive a player betting selection for a player, the player betting selection comprising placing of the first wager on the player betting area;
a banker betting area configured to receive a banker betting selection for a banker, the banker betting selection comprising placing of the first wager on the banker betting area; and
a tie betting area configured to receive a tie betting selection for a tie, the tie betting selection comprising placing of the first wager on the tie betting area.

35. The system of claim 34, wherein said plurality of side-betting areas comprise:
a player side-betting area associated with the player betting area, the player side-betting area comprising at least one side bet sign;
a banker side-betting area associated with the banker betting area, the banker side-betting area comprising at least one side bet sign; and
a tie side-betting area associated with the tie betting area, the tie side-betting area comprising at least one side bet sign.

36. The system of claim 35, wherein each side bet sign is unique.

37. The system of claim 35, wherein each side bet sign comprises a Western Zodiac sign.

38. The system of claim 35, wherein each side bet sign comprises an Asian Zodiac sign.

39. The system of claim 35, wherein each side bet sign comprises one of a numeric value, text, or image representing a Western Zodiac sign or an Asian Zodiac sign.

40. The system of claim 33, wherein said random number generator comprises a die having a plurality of sides, each side respectfully corresponds to each of the side bet signs, wherein the outcome corresponds to a side of the die that is facing up after rolling.

41. The apparatus of claim 40, wherein the die has 12 sides, each side indicates a unique side bet sign.

42. The apparatus of claim 33, wherein said playing further comprises causing odds for winning the side bet to change, wherein the odds for generating each outcome representing each of the side bet signs is randomly increased or decreased.

43. The apparatus of claim 42, wherein the user interface device is configured to allow the user to activate the causing of odds for winning the side bet to change.
